(19) United States
(12) Patent Application Publication
(10) Pub. No.: US 2014/0317538 A1
(43) Pub. Date: Oct. 23, 2014

(54) USER INTERFACE RESPONSE TO AN ASYNCHRONOUS MANIPULATION

(71) Applicant: MICROSOFT CORPORATION, Redmond, WA (US)

(72) Inventors: Nathan Pollock, Seattle, WA (US); Lauren Gust, Bellevue, WA (US); Nicolas Brun, Seattle, WA (US); Nicholas Waggoner, Newcastle, WA (US); Michael Nelte, Redmond, WA (US)

(73) Assignee: Microsoft Corporation, Redmond, WA (US)

(21) Appl. No.: 13/867,142

(22) Filed: Apr. 22, 2013

(51) Int. Cl. G06F 3/0484

(52) U.S. Cl. CPC G06F 3/04842
USPC 715/762

(57) ABSTRACT

In one embodiment, a graphical display device may synchronize movement between a primary content set 204 and a reflex content set 206 to create a parallax effect in a graphical user interface 202. The graphical display device may detect a user input indicating a primary position change 206 of a primary content set 204 in a graphical user interface 202. The graphical display device may instantiate a delegate thread to control a reflex content set 208. The graphical display device cause a reflex content set 208 to move in a controlled independent action 210 based on the primary position change 206.

### BACKGROUND

The input mechanisms for computing devices have increased in complexity of interactions offered and ease of use. A touch screen may allow a user to easily manipulate content in a graphical user interface using just a single finger. For example, a user may place a finger on the touch screen to select a content item. The user may then drag that finger across the screen, moving the selected item within the framework of the graphical user interface.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to synchronizing movement between a primary content set and a reflex content set to create a parallax effect in a graphical user interface. The graphical display device may detect a user input indicating a primary position change of a primary content set in a graphical user interface. The graphical display device may instantiate a delegate thread to control a reflex content set. The graphical display device cause a reflex content set to move in a controlled independent action based on the primary position change.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of a graphical user interface interaction.

FIG. 3 illustrates, in a graph, one embodiment of an event time graph.

FIG. 4 illustrates, in a flowchart, one embodiment of a method of moving a primary content set.

FIG. 5 illustrates, in a flowchart, one embodiment of a method of predicting a future primary position.

FIG. 6 illustrates, in a flowchart, one embodiment of a method of moving a reflex content set.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a graphical display device.

Some user experience scenarios may move certain user interface elements relative to other user interface elements. However, an independent thread may transform some user interface elements, making alignment and synchronization difficult. Additionally, with the advent of touch screens, a user may manipulate multiple user interface elements independently. The other user interface elements may be unable to know the exact motion of the main user interface elements. An example of this type of scenario may be “parallax panning.” In this scenario, the parallax element may move at a velocity proportional to the speed of other elements to create the illusion of depth. A parallax background may scroll at a much slower speed than the foreground content to create the illusion that the parallax background is much further away from the user.

A graphical display device may handle input using a separate delegate thread. The graphical display device may compute a transform matrix that is applied to the main, or primary, content, such as a user interface element. The transform matrix may account for panning, scaling, rotation, animation, and transforms applied by developers. A secondary, or reflex, content behavior can be coded internally by implementing a dedicated interface which allows each new behavior to integrate with the main processing infrastructure. The dedicated internal interface may define a set of input variables, in relationship with other content, such as the primary content. These definitions may allow the dedicated internal interface to know which other content may be used to compute its own transform. The dedicated internal interface may use a synchronization point to compute an updated position. The dedicated internal interface may use a synchronization point to present every updated position on screen, across the set of behaviors, atomically.

A user of the public application programming interface may not be aware of these internal mechanisms. The user may create a new instance of a reflex content by choosing from a set of built-in behaviors made available to the application, and then configure various parameters based on behavior chosen to associate the reflex content with a primary content or other ancillary content. Once an application creates new reflex content and associates the reflex content with a particular primary content, an application programming interface may extract the synchronization information, such as current position and size of the primary content and a list of targeted content.

The graphical display device may update the mathematical position of the primary content before presentation on screen. Then, synchronously, the delegate thread may check each primary content set for any associated reflex content set. For any associated reflex content set, the architecture may request an updated position based on the current position of the primary content set. The architecture may organize the requests in the order that each reflex content set was added to the system for a given primary content set. A later reflex content set may then also consume the newly computed position for ancillary content set in order to compute the reflex content position. Once each reflex content position is computed, the graphical display device may update the position of each associated visual, commit the changes atomically.

Thus, in one embodiment, a graphical display device may synchronize movement between a primary content set and a reflex content set to create a parallax effect in a graphical user interface. The graphical display device may detect a user input indicating a primary position change of a primary content set in a graphical user interface. The graphical display device may instantiate a delegate thread to control a reflex content set. The graphical display device cause a reflex content set to move in a controlled independent action based on the primary position change.

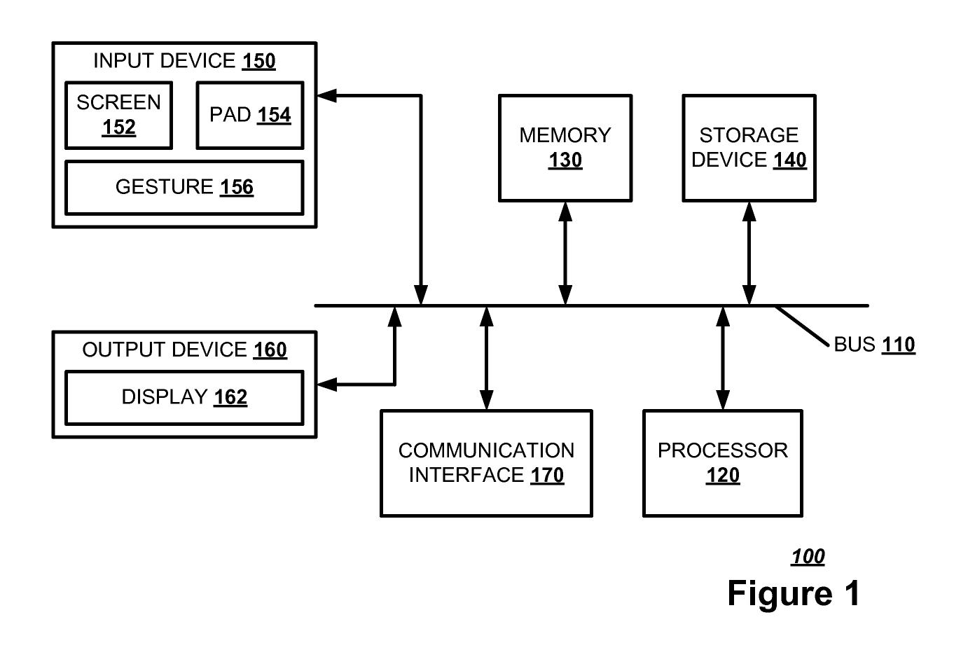

FIG. 1 illustrates a block diagram of an exemplary computing device 100 which may act as a graphical display device. The computing device 100 may combine one or more of hardware, software, firmware, and system-on-a-chip technology to implement a graphical display device. The computing device 100 may include a bus 110, a processor 120, a memory 130, a data storage 140, an input device 150, an output device 160, and a communication interface 170. The bus 110, or other component interconnection, may permit communication among the components of the computing device 100.

The processor 120 may include at least one conventional processor or microprocessor that interprets and executes a set of instructions. The memory 130 may be a random access memory (RAM) or another type of dynamic data storage that stores information and instructions for execution by the processor 120. The memory 130 may also store temporary variables or other intermediate information used during execution of instructions by the processor 120. The data storage 140 may include a conventional ROM device or another type of static data storage that stores static information and instructions for the processor 120. The data storage 140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 140 may store a set of instructions detailing a method that when executed by one or more processors cause the one or more processors to perform the method.

The input device 150 may include one or more conventional mechanisms that permit a user to input information to the computing device 100, such as a keyboard, a mouse, a voice recognition device, a microphone, a headset, a touch screen 152, a track pad 154, a gesture recognition device 156, etc. The output device 160 may include one or more conventional mechanisms that output information to the user, including a display 162, a printer, one or more speakers, a headset, or a medium, such as a memory, or a magnetic or optical disk and a corresponding disk drive. A touch screen 152 may also act as a display 162, while a track pad 154 merely receives input. The communication interface 170 may include any transceiver-like mechanism that enables computing device 100 to communicate with other devices or networks. The communication interface 170 may include a network interface or a transceiver interface. The communication interface 170 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 170.

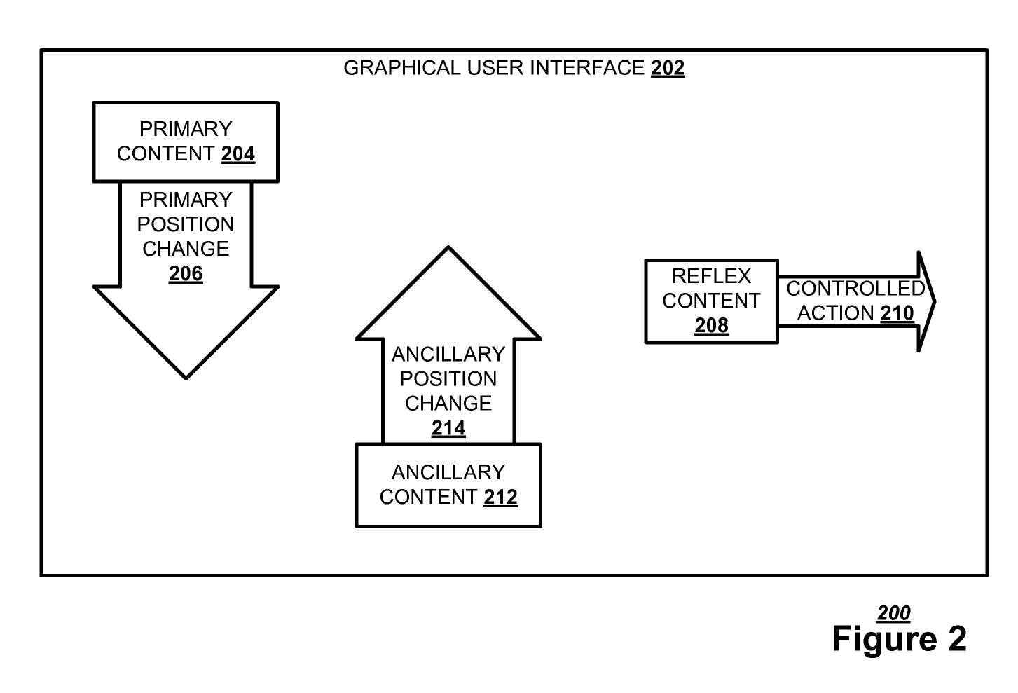

FIG. 2 illustrates, in a block diagram, one embodiment of a graphical user interface interaction 200. A graphical user interface 202 may have a background that may be static or dynamic. A primary content set 204 may experience a primary position change 206 relative to the background of the graphical user interface 202. A primary content set 204 is a set of one or more user interface elements that is being directly manipulated by the user, such as an icon, an interactive tile, a media item, or other graphical objects. The primary content set 204 may not be a null set.

A reflex content set 208 may experience a controlled independent action 210 based on the primary position change 206. The reflex content set 208 is a set of one or more user interface elements subject to the control independent action 210. The reflex content set 208 may not be a null set. The controlled independent action 210 is a controlled action sought by the user and not an uncontrolled reaction to the primary position change 206. The controlled independent action 210 may also act independently of the primary content set 204.

For example, a primary content set 204, such as an interactive tile, may execute the primary position change 206 of moving across the graphical user interface 202 at a set speed in a set direction. A reflex content set 208, such as a background pattern may execute a controlled independent action 210 of moving the reflex content set 208 at half the set speed in the set direction. The variation between the primary position change 206 of the primary content set 204 and the controlled independent action 210 of the reflex content set 208 may interact to provide the illusion of depth of field in the graphical user interface 202. This illusion of a depth of field is referred to as a parallax effect.

An ancillary content set 212 may experience an ancillary position change 214 relative to the background of the graphical user interface. The ancillary content set 212 is a set of one or more user interface elements, but may not be null set. The ancillary position change 214 may be a controlled independent action 210 in response to the primary position change 206 of the primary content set 204. Alternately, the ancillary position change 214 may be a wholly or partially independent action. A user input may cause ancillary position change 214. Further, the controlled independent action 210 of the reflex content set 208 may be partially based on the ancillary position change 214. Thus, a primary position change 206 for a primary content set 204 and an ancillary position change 214 for the ancillary content set 212 may cause the reflex content set 208 to execute a controlled independent action 210. In the above example, an ancillary content set 212, such as a different interactive tile, may execute an ancillary position change 214 of moving at a different speed in a perpendicular direction, causing the controlled independent action 210 of moving the reflex content set 208 in an angular direction. The variation between the primary position change 206 of the primary content set 204, the ancillary position change 214 of the ancillary content set 212, and the controlled independent action 210 of the reflex content set 208 may interact to create a parallax effect.

The graphical display device may apply a smoothing filter to the primary position change 206 to remove any accidental glitches caused by user tremors during the user input or inaccuracies due to hardware noise. The graphical display device may predict a future primary position for the primary content set 204 to reduce latency between input and position for the graphical display device output. The graphical display device may synchronize the prediction of the future primary position with a prediction of a future reflex position of the reflex content set 208. The graphical display device may use a prediction generator as a smoothing filter, or may keep the two operations separate. The prediction generator may be used to correct for intermediate errors when multiple inputs are being processed. The prediction generator may compensate in the controlled independent action 210 for any prediction errors in the primary position change 206.

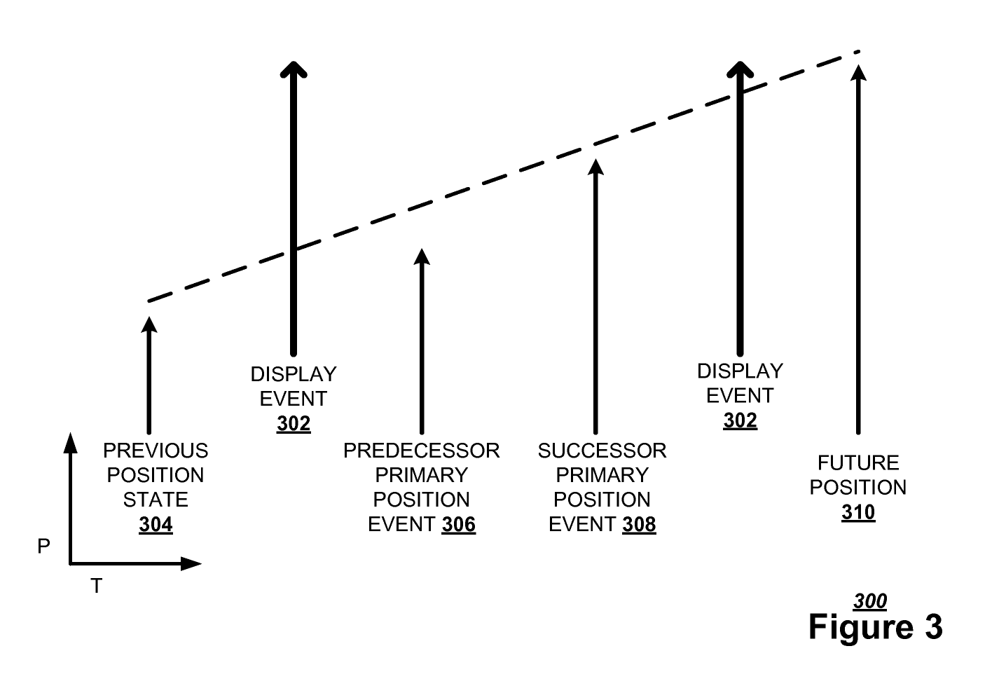

FIG. 3 illustrates, in a graph, one embodiment of an event time graph 300. The graphical display device may refresh the graphical user interface during a display event 302 at a display rate. A user movement interface of the graphical display device, such as a touch screen 152, a track pad 154, or a gesture recognition device 156, may sample a position of the user on the user movement interface during an input read event at an input rate. The input rate may be different from the display rate.

A graphical display device may store a previous reflex position state 304 representing the position of a reflex content set 208 prior to the most recent display event 302. The user movement interface may receive an input read event after the display event 302. If the user movement interface receives a second input read event after the first input read event, the first input read event may become a predecessor primary position event 306 and the second input read event may become a successor primary position event 308. The user movement interface may discard the predecessor primary position event 306 in favor of the successor primary position event 308. The graphical display device may use the successor primary position event 308 in conjunction with the previous reflex position state 304 to predict a future reflex position 310.

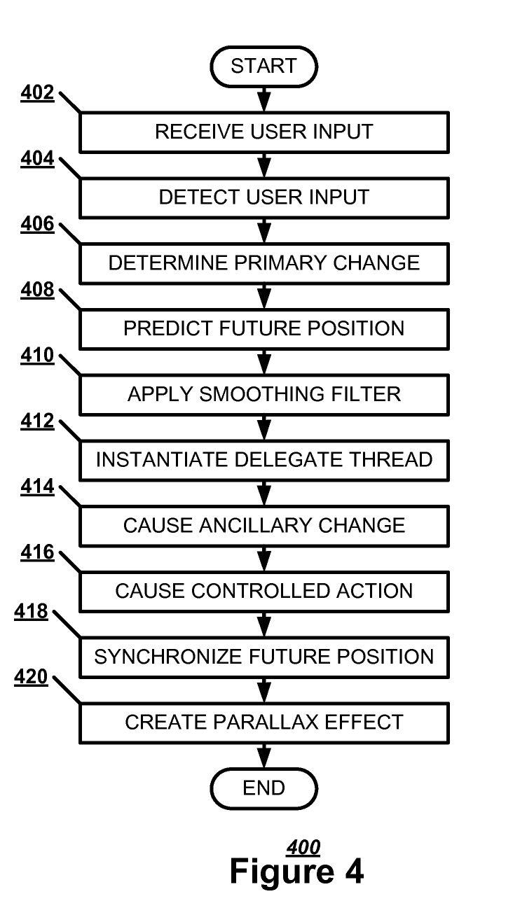

FIG. 4 illustrates, in a flowchart, one embodiment of a method 400 of moving a primary content set 204. The graphical display device may receive a user input at an input rate different from a display rate for displaying the graphical user interface (Block 402). The graphical display device may detect a user input indicating a primary position change 206 of a primary content set 204 in a graphical user interface (Bloc 404). The graphical display device may determine the primary position change 206 is at least one of a pan, a scale, and a rotation (Block 406). The graphical display device may predict a future primary position 310 for the primary content set 204 based on a current input read event and a previous primary position state 304 (Block 408). The graphical display device may apply a smoothing filter to the primary position change 206 (Block 410). The graphical display device may instantiate a delegate thread to control a reflex content set 208 (Block 412). The graphical display device may cause an ancillary position change 214 of an ancillary content set 212 that factors into a controlled independent action 210 (Block 414). The graphical display device may cause a reflex content set 208 to move in a controlled independent action 210 based on the primary position change 206 and possibly an ancillary position change 214 (Block 416). The graphical display device may synchronize a predicted future primary position 310 for the primary content set 204 to a predicted future reflex position for the reflex content set 208 (Block 418). The graphical display device may create a parallax effect using an interaction between the primary position change, the ancillary position change, and the controlled independent action (Block 420).

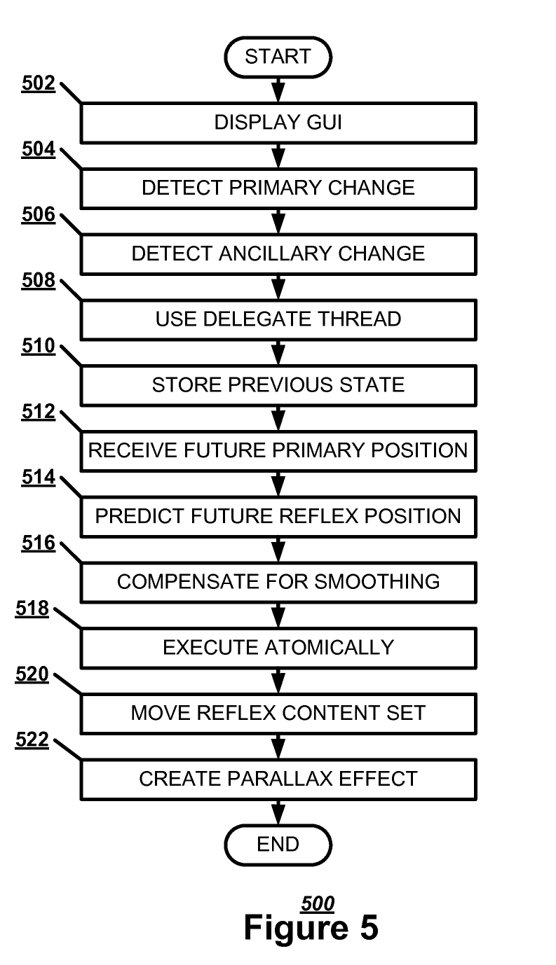

FIG. 5 illustrates, in a flowchart, one embodiment of a method 500 of moving a reflex content set 208. The graphical display device may display a graphical user interface 202 at a display rate different from an input rate for receiving the user input (Block 502). The graphical display device may detect a primary position change 206 of a primary content set 204 in a graphical user interface based on the user input (Block 504). The graphical display device may detect an ancillary position change 214 of an ancillary content set 212 in the graphical user interface 202 (Block 506). The graphical display device may use a delegate thread to execute the controlled independent action 210 (Block 508). The graphical display device may store a previous reflex position state for the reflex content set 208 (Block 510). The graphical display device may receive a predicted future primary position 310 for synchronization (Block 512). The graphical display device may predict a future reflex position for the reflex content set based on the predicted future primary position (Block 514). The graphical display device may compensate in the controlled independent action 210 for a smoothing filter applied to the primary position change 206 (Block 516). The graphical display device may execute the ancillary position change 214 and the controlled independent action 210 atomically (Block 518). The graphical display device may move a reflex content set 208 in a controlled independent action 210 based on the primary position change 206 and the ancillary position change 214 (Block 520). The graphical display device may create a parallax effect using an interaction between the primary position change, the ancillary position change, and the controlled independent action (Block 522).

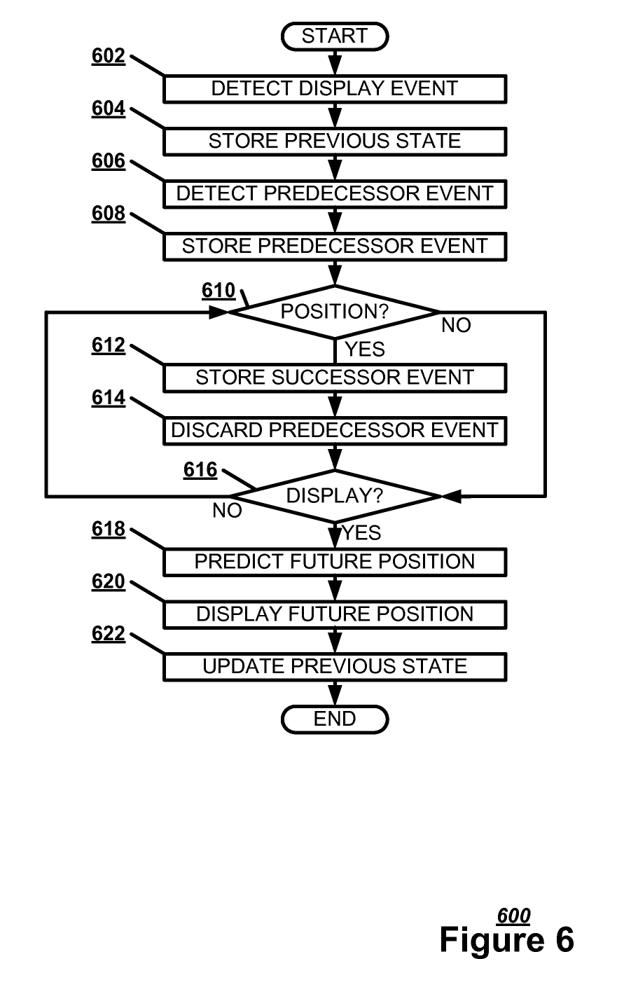

FIG. 6 illustrates, in a flowchart, one embodiment of a method 600 of predicting a future primary position 310. The graphical display device may detect a display event 302 for a graphical user interface (Block 602). The graphical display device may store a previous reflex position state 304 for the reflex content set 208 (Block 604). The graphical display device may detect a predecessor primary position event 306 (Block 606). The graphical display device may store a predecessor primary position event 306 (Block 608). If a successor primary position event 308 occurs prior to a display event 302 (Block 610), the graphical display device may store the successor primary position event 308 (Block 612). The graphical display device may discard the predecessor primary position event 306 (Block 614). If a display event occurs (Block 616), the graphical display device may predict a future reflex position 310 for the reflex content set 208 based on a current primary position event and the previous reflex position state 304 (Block 618). The graphical display device may display the future reflex position 310 for the reflex content set 208 (Block 620). The graphical display device may update the previous reflex position state 304 for the reflex content set 208 after a display event 302 (Block 622).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
detecting a primary position change of a primary content set in a graphical user interface based on a user input;
detecting an ancillary position change of an ancillary content set in the graphical user interface; and
moving a reflex content set in a controlled independent action based on the primary position change and the ancillary position change.

2. The method of claim 1, further comprising:
using a delegate thread to execute the controlled independent action.

3. The method of claim 1, further comprising:
executing the ancillary position change and the controlled independent action atomically.

4. The method of claim 1, further comprising:
compensating in the controlled independent action for a smoothing filter applied to the primary position change.

5. The method of claim 1, further comprising:
displaying the graphical user interface at a display rate different from an input rate for receiving the user input.

6. The method of claim 1, further comprising:
receiving a predicted future primary position for synchronization.

7. The method of claim 1, further comprising:
predicting a future reflex position for the reflex content set based on a predicted future primary position.

8. The method of claim 1, further comprising:
storing a previous reflex position state for the reflex content set.

9. The method of claim 1, further comprising:
detecting a predecessor primary position event.

10. The method of claim 1, further comprising:
discarding a predecessor primary position event if a successor primary position event occurs prior to a display event.

11. The method of claim 1, further comprising:
predicting a future reflex position for the reflex content set based on a current primary position event and a previous reflex position state.

12. The method of claim 1, further comprising:
updating a previous reflex position state for the primary content set after a display event.

13. The method of claim 1, further comprising:
creating a parallax effect using an interaction between the primary position change, the ancillary position change, and the controlled independent action.

14. A tangible machine-readable medium having a set of instructions detailing a method stored thereon that when executed by one or more processors cause the one or more processors to perform the method, the method comprising:
detecting a user input indicating a primary position change of a primary content set in a graphical user interface;
instantiating a delegate thread to control a reflex content set;
causing a reflex content set to move in a controlled independent action based on the primary position change; and
creating a parallax effect using an interaction between the primary position change and the controlled independent action.

15. The tangible machine-readable medium of claim 14, wherein the method further comprises:
determining the primary position change is at least one of a pan, a scale, and a rotation.

16. The tangible machine-readable medium of claim 14, wherein the method further comprises:
causing an ancillary position change of an ancillary content set that factors into the controlled independent action.

17. The tangible machine-readable medium of claim 14, wherein the method further comprises:
receiving a user input at an input rate different from a display rate for displaying the graphical user interface.

18. The tangible machine-readable medium of claim 14, wherein the method further comprises:
synchronizing a predicted future primary position for the primary content set to a predicted future reflex position for the reflex content set.

19. A graphical display device, comprising:
an input device that receives a user input directing a primary position change of a primary content set in a graphical user interface; and
a processor that applies a smoothing filter to the primary position change and causes a reflex content set to move in a controlled independent action based on the primary position change to create a parallax effect.

20. The graphical display device claim 19, wherein the processor predicts a future reflex position for the reflex content set based on a predicted future primary position.
